(19) United States
(12) Patent Application Publication
(10) Pub. No.: US 2007/0243452 A1
(43) Pub. Date: Oct. 18, 2007

(54) RELIABLE FUEL CELL ELECTRODE DESIGN

(75) Inventors: Timothy W. Weidman, Sunnyvale, CA (US); Karl J. Armstrong, San Jose, CA (US); David J. Eaglesham, Perrysburg, OH (US); Nety Krishna, Sunnyvale, CA (US); Ralf Hofmann, Soquel, CA (US); Michael P. Stewart, Mountain View, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/734,913

(22) Filed: Apr. 13, 2007

Related U.S. Application Data
(60) Provisional application No. 60/792,123, filed on Apr. 14, 2006.
(60) Provisional application No. 60/792,599, filed on Apr. 17, 2006.

(51) Int. Cl. H01M 4/92; H01M 8/02; H01M 4/88; B05D 5/12

(52) U.S. Cl. 429/44; 429/38; 427/115; 502/101

(57) ABSTRACT

The present invention generally relates to the creation of fuel cell components and the method of forming the various fuel cell components that have an improved lifetime, lower production cost and improved process performance. The invention generally includes treating or conditioning a substrate surface by depositing a material layer, or layers, having good adhesion to the substrate, low electrical resistivity (high conductivity) and has good resistance to chemical attack during the operation of fuel cell. The substrate may be, for example, a fuel cell part, a conductive plate, a separator plate, a bipolar plate or an end plate, among others. In one embodiment, the substrate surface is treated or conditioned by exposing at least a portion of it to a gas or liquid comprising ruthenium tetroxide.

### CROSS-REFERENCE TO RELATED APPLICATIONS

This application claims benefit of U.S. Provisional Patent Application Ser. No. 60/792,123, filed Apr. 14, 2006, and U.S. Provisional Patent Application Ser. No. 60/792,599, filed Apr. 17, 2006, which are both herein incorporated by reference.

### BACKGROUND OF THE INVENTION

1. Field of the Invention

Embodiments of the present invention generally relate to the deposition of thin films. More particularly, this invention relates to a process and apparatus for depositing a thin film onto a substrate surface.

2. Description of the Related Art

Developing environmentally friendly energy sources have gained significant interest recently in various industries related to the generation of power and electricity. Various types of fuel cells can be used to directly produce electricity for a number of applications, such as portable electronics, cell phones, wireless devices, PDAs, cameras, portable players, computer notebooks, mobile vehicles (e.g., cars, trucks, trains, etc.), stationary large size energy equipment, residential electricity and others. Since semiconductor machining technology can be easily utilized in fuel cell manufacturing, efficient production of electricity by fuel cells is feasible.

A fuel cell is an electrochemical device in which a gaseous or liquid fuel reacts with an oxidant to produce electricity. Generally, an electrolyte is sandwiched by two electrodes, an anode and a cathode, to form a fuel cell unit. A fuel, such as pure hydrogen or hydrogen reformed from any hydrocarbon fuel, is fed into the anode to be oxidized into a proton and an electron. An oxidant, such as air or oxygen, is flowed into the cathode to react with the proton which has passed through the electrolyte and, in some cases, through a proton-permeable membrane. The generated electrons flow from the anode to the cathode where the electrons are reunited with the proton and the oxidant, resulting in by-products, such as heat and water. The generated flow of electrons thus creates a current that delivers the power to drive external devices. Each fuel cell unit is stacked or arranged together to form a fuel cell stack or module. A number of modules or fuel cell stacks are piled, and electrical terminals, electrical insulators and end plates are disposed at opposite ends of the pile of modules to collectively produce electricity. The essentials of a fuel cell are generally simple, leading to highly reliable and long-lasting electricity/energy generating applications.

Generally, a fuel cell stack uses a number of conductive plates placed between adjacent fuel cells in a fuel cell stack to separate each fuel cell. The conductive plates usually incorporate flow channels or grooves for feeding and moving any fuel gas, oxidant or fluid through the fuel cell. The conductive plates may be made of metals, heavily doped semiconductors, or conductive polymers, such as a carbon-filled composite. Each conductive plate includes one side for flowing fuel gases or oxidant gases. The conductive plates placed between adjacent fuel cells in a fuel cell stack are generally called a bipolar plate or a separator plate and the conductive plates placed at both ends of a fuel cell stack are also called end plates. It should be noted that in a unipolar plate configuration, the other side of the conductive plate generally contains cooling channels or conduits, which are mated with the cooling channels from an adjacent fuel cell in a fuel cell stack to form into a mated conductive plate having an internal cylindrical path for flowing coolants to move the heat and water produced from the chemical reactions at an anode and/or a cathode away from the fuel cell stack. Thus in a unipolar plate configuration the mated conductive plates include one side to serve as an anode for one fuel cell and the other side to act as a cathode for an adjacent fuel cell, and thus two unipolar plates mated together act as a bipolar plate.

The electrolyte plays a key role in a fuel cell to carry protons from the anode to the cathode. The electrolyte includes various types of organic and inorganic chemicals and, thus, different types of fuel cells are formed depending on the types of chemicals used. One type of fuel cells is a phosphoric acid fuel cells (PAFC) that uses phosphoric acid at elevated temperatures (e.g., 150 to 200° C.). Other types of fuel cells includes solid oxide fuel cells (SOFC), molten carbonate fuel cells (MCFC), direct methanol fuel cells (DMFC), polymer electrolyte membrane fuel cells (PEMFC), alkaline fuel cells (AFC), among others.

One type of fuel cell uses a proton exchange membrane that is permeable to protons, but not to gases or electrons. In this configuration, a typical proton exchange membrane will have the surfaces on opposing sides coated with different catalysts, which accelerates the different chemical reactions at the anode and the cathode. The membrane is sandwiched by two microporous conductive layers (which function as the gas diffusion layers and current collectors) to contact the hydrogen fuel on one side (e.g., anode side) and contact the oxidant on the other side (e.g., cathode side) to form a membrane electrode assembly (MEA). A PAFC type fuel cell may use a proton exchange membrane or a porous structure that supports the electrolyte.

The MEA must permit only the proton to pass between the anode and the cathode. If free electrons or other substances travel through the MEA, they would disrupt the chemical reactions and short circuit part of the current. Further, in order for a fuel cell to operate properly with high electrical output and reliability, the gas and fluids must be moved through the surface of parts, channels, conduits, passages, grooves and/or holes inside the fuel cell without interruption under a wide variety of operating conditions. As such, the surface properties of any fuel cell parts must be conditioned to facilitate and enable this movement. In addition, various parts of a fuel cell stack or module should provide a surface with good contact to electrolyte, current or any gas, fluid present in the fuel cell stack.

To make fuel cells more of a viable product in the energy market it is important to increase the fuel cell's lifetime, reduce the costs to produce the fuel cell, and improve the efficiency of the formed fuel cell device. One problem that arises with respect to both the conductive plates and the end plates in a fuel cell stack is that they are subject to corrosion attack by the components in the electrolyte in most fuel cell applications. For example, in a phosphoric acid fuel cells (PAFC), the high temperatures and the presence of acidic environment makes the conductive plates and end plates highly susceptible to attack and corrosion.

Thus, there is still a need for method and apparatus for forming the conductive plates and end plates that have an improved lifetime, and reduced production cost. There is also a need for a fuel cell that has an improved efficiency.

### SUMMARY OF THE INVENTION

Embodiments of the invention generally provide an electrode for a fuel cell, comprising a substrate having a surface that is adapted to form a portion of a fluid channel in an assembled fuel cell, and a ruthenium containing coating disposed over the surface of the substrate, wherein the ruthenium coating is adapted to prevent corrosion of the surface during operation of the fuel cell.

Embodiments of the invention further provide a fuel cell, comprising a membrane electrode assembly comprising a membrane, and one or more conductive plates having a material layer on one or more surfaces thereof, the one or more surfaces of the one or more conductive plates having a coating disposed onto a portion of the one or more surfaces of the one or more conductive plates, wherein the coating comprises a first layer disposed over the surface of the substrate, and a ruthenium containing layer disposed over the first layer, wherein the ruthenium coating is adapted to prevent corrosion of the one or more surfaces during operation of the fuel cell.

Embodiments of the invention further provide a bipolar plate having one or more surfaces, comprising a material layer deposited onto a portion of the one or more surfaces, the one or more surfaces having a coating disposed on one or more surfaces of the one or more bipolar plates, wherein the coating comprises: a first layer disposed over the surface of the substrate, and a ruthenium containing layer disposed over the first layer, wherein the ruthenium containing layer is adapted to prevent corrosion of the one or more surfaces during operation of the fuel cell.

Embodiments of the invention further provide a method of treating a surface of a substrate that is to be used to form a fuel cell, comprising providing a substrate that has a surface that is adapted to form a portion of a fluid channel in an assembled fuel cell, and depositing a ruthenium containing layer on the surface of the substrate, wherein the ruthenium containing layer is adapted to prevent corrosion of the surface during operation of the fuel cell.

Embodiments of the invention further provide a method of treating a surface of a substrate that is to be used to form a fuel cell, comprising providing an assembled fuel cell having a fluid channel that is in communication with a catalytic surface of an electrode region of the fuel cell and delivering a ruthenium tetraoxide containing gas to the fluid channel and catalytic surface of the electrode region of the fuel cell to deposit a ruthenium containing layer on a portion of the fluid channel or catalytic region.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a simplified schematic view of an active region of a fuel cell unit;

FIG. 2 illustrates an active region of the fuel cell that has multiple bipolar plates according to one embodiment described herein;

FIG. 3 illustrates, one embodiment, in which the surface of one side of a bipolar plate according to one embodiment described herein;

FIG. 4A illustrates a cross-sectional view of a protrusion formed on a surface of the substrate according to one embodiment described herein;

FIG. 4B illustrates a cross-sectional view of a prior art coating disposed on the protrusion illustrated in FIG. 4A;

FIG. 5 illustrates a cross-sectional view of a protrusion having an exemplary coating formed on a surface of the substrate according to one embodiment described herein;

FIG. 6 illustrates a cross-sectional view of a deposition chamber that may be adapted to perform an embodiment described herein;

FIG. 7 illustrates a process sequence according to one embodiment described herein;

FIG. 8A illustrates an active region of the fuel cell that has multiple bipolar plates according to one embodiment described herein;

FIG. 8B illustrates an active region of the fuel cell that has multiple bipolar plates according to one embodiment described herein.

### DETAILED DESCRIPTION

The present invention generally relates to the creation of fuel cell components and the method of forming the various fuel cell components that have an improved lifetime, lower production cost and improved process performance. The invention generally includes treating or conditioning a substrate surface by depositing a material layer, or layers, having good adhesion to the substrate, low electrical resistivity (high conductivity) and has good resistance to chemical attack during the operation of fuel cell. The substrate may be, for example, a fuel cell part, a conductive plate, a separator plate, a bipolar plate, unipolar plate, or an end plate, among others. However, the invention is equally applicable to other types of substrates. Substrates of the invention can be of any shape (e.g., circular, square, rectangle, polygonal, etc.) and size. Also, the type of substrate is not limiting and can be any substrate comprised of a metal, plastic, semiconductor, glass, carbon-containing polymer, composite, or other suitable materials.

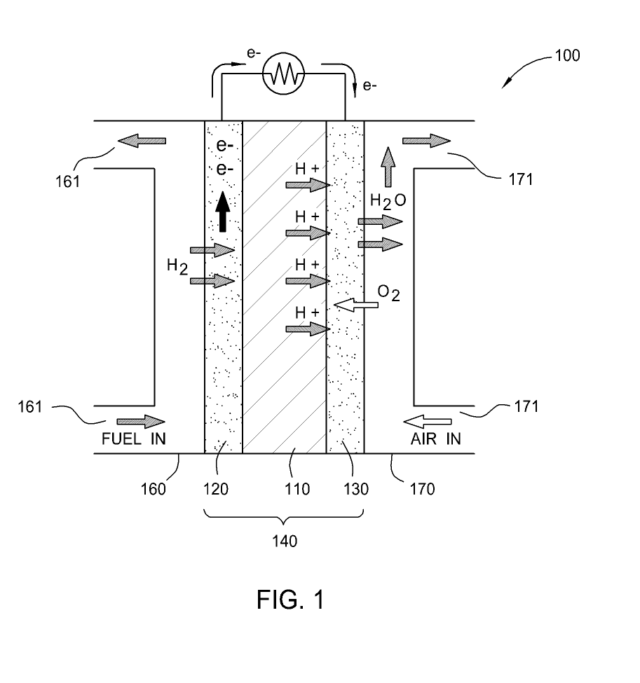

FIG. 1 illustrates a simplified schematic view of an active region 140 of a fuel cell 100. The active region 140 generally contains a membrane 110, an anode catalyst region 120, a cathode catalyst region 130, an anode separator plate 160 and a cathode separator plate 170. The membrane 110 is generally coated with an anode catalyst region 120 and a cathode catalyst region 130 to form a membrane electrode assembly (MEA). The membrane 110 can be made from an ion exchange resin material, polymeric material, or a porous inorganic support that may be rendered impermeable to the flow gases after saturation with the electrolyte. For example, an ionic perfluoronated sulfonic acid polymer membrane, such as Nafion™, available from the E.I. DuPont de Nemeours & Co. Other suitable membrane materials include Gore Select™, sulphonated fluorocarbon polymers, the polybenzimidazole (PBI) membrane (available from Celanese Chemicals, Dallas, Tex.), polyether ether ketone (PEEK) membranes and other materials. An example of a porous inorganic material may include ceramic or other inorganic dielectric materials. In one example, the membrane 110 is made from a polymeric material, such as a polybenzimidazole (PBI) membrane material. Various suitable catalyst formulations for the cathode catalyst region 130 and the anode catalyst region 120 are known in the art and are generally platinum-based with very finely divided catalytic particles supported on internal and external surfaces of a carbon binder, and often impregnated with a polytetrafluorethylene (PTFE) binder. The anode catalyst region 120 and cathode catalyst region 130 generally contain one or more catalytic materials disposed on an electrode section that is porous and gas-permeable and are generally made from carbon paper or cloth-based fibers, graphite materials, or finely-meshed noble metal screen, foams, or other materials known in the art.

A pair of gas impermeable, non-porous, electrically conductive plates, such as an anode separator plate 160 and a cathode separator plate 170, sandwich the MEA. The anode separator plate 160 and the cathode separator plate 170 generally have fluid channels 161 and 171, respectively, which are adapted to carry and deliver the fuel or oxidizing components to the surface of the MEA. One side of the anode separator plate 160 contains a fluid channel 161 that distributes and routes gaseous reactants, such as H₂ and other fuel gases, to the surface of the anode. One side of the cathode separator plate 170 in the fuel cell 100 contains a fluid channel 171 that distributes and routes gaseous reactants, such as O₂, air, and other oxidants, to the surface of the cathode. These fluid channels 161, 171 generally include a plurality of flow channels, grooves, conduits, features through which the gaseous reactants can flow between gas supplies (not shown) and gas exhausts (not shown).

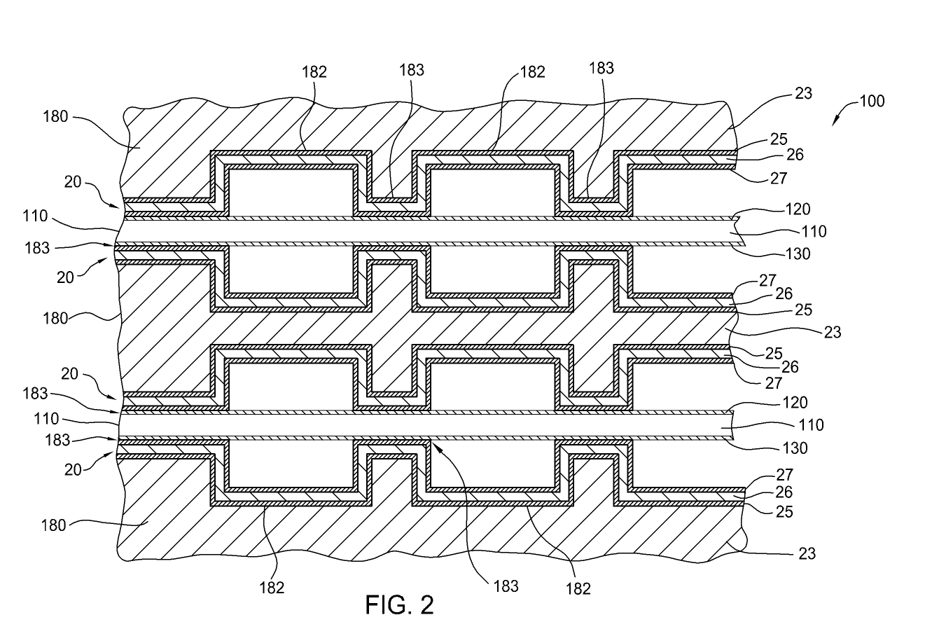

FIG. 2 illustrates a more complex version of the active region 140 of the fuel cell in which multiple bipolar plates 180 are stacked to form a fuel cell that has an increased energy output. In this configuration the anode separator plates 160 and cathode separator plates 170, as shown in FIG. 1, are formed regions on opposing sides of the bipolar plates 180. In this case, one side of the bipolar plate 180 is exposed to the fuel gases and the other side is exposed to the oxidant gases. The bipolar plate 180 provides electrical contact between the anodes and cathodes of neighboring fuel cells while preventing the hydrogen and oxygen reactant gases from mixing.

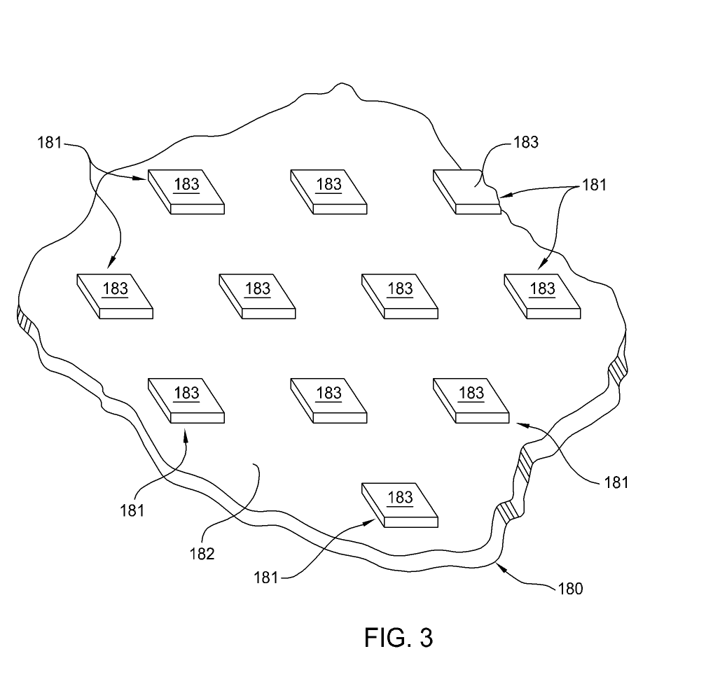

FIG. 3 illustrates, one embodiment, in which the surface of one side of a bipolar plate 180 contains a plurality of protrusions 181 that are adapted to space the MEA from base region 182 of the bipolar plate 180 so that a fluid channel (e.g., items # 161 or 171) is formed when the protrusion tops 183 of the bipolar plate 180 are in physical and electrical contact with the anode catalyst region 120 or cathode catalyst region 130 of the MEA (see FIGS. 2 and 3).

In one embodiment, the bipolar plate 180 contains a substrate 23 that has a coating 20 disposed on one or more surfaces to prevent the substrate 23 from being attacked by the electrolyte and/or byproducts of the reactions in the fuel cell. This configuration is especially advantageous, since the material from which the substrate 23 is selected, can be a material that is relatively inexpensive, has a low mass density and can be easily machined to form the various required features on the exposed surfaces. Typical features may include forming the fluid channels 161 and 171 and various heating/cooling channels (not shown). In general a suitable substrate 23 material include, but is not limited to metal alloys (e.g., stainless steel, titanium, aluminum), semiconductors materials (e.g., silicon (Si), heavily doped Si), carbon containing materials (e.g., graphite), or conductive polymers. In this configuration, the substrate 23 is protected with a corrosion-resistant and electrically conductive coating (e.g., coating 20) for enhancing the transfer of thermal and electrical energy.

In one embodiment, the coating 20 contains one or more layers of material that each may act as an electrically conducting layer, an electrical contact element, and/or a layer that protects the substrate 23 material. The configuration is especially important to form a low cost fuel cell that will reliably work in a highly aggressive environment, such as, a PAFC application that uses phosphoric acid at temperatures that are generally in the range of about 150° C. to about 200° C. A coating that contains cracks, holes or other type of defects will allow the substrate 23 material to be attacked and then eventually cause failure of the fuel cell. This problem is especially important where a substrate 23 is formed from a silicon containing material that is exposed to phosphoric acid contained in the PAFC, since the etch rate of silicon (Si) is very high when exposed to phosphoric acid at these temperatures.

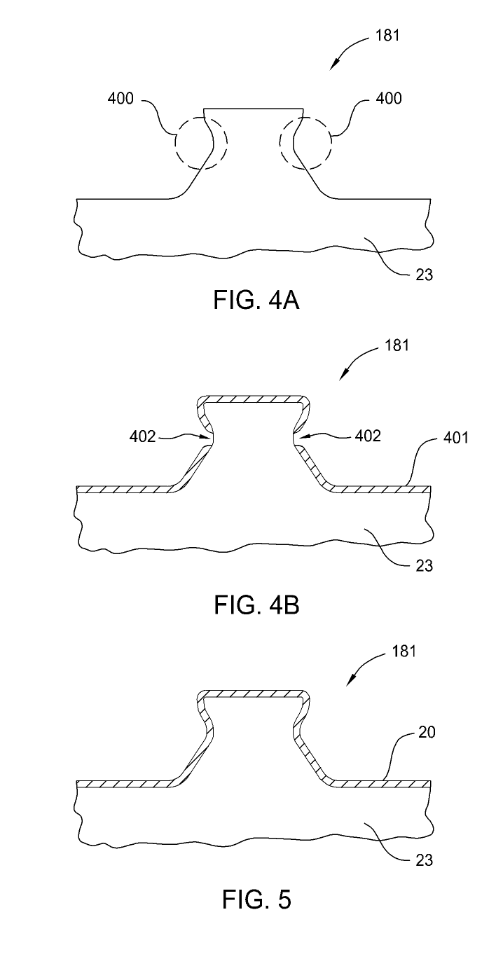

One example of a PAFC structure utilizes gold (Au) coated silicon substrates that have a tantalum (Ta) adhesion layer between the gold layer and silicon substrates. Conventionally formed coatings employing metal evaporators do not form a coating that is defect free, which thus allows the electrolyte and/or byproducts of the reactions in the fuel cell to damage the substrate 23. One issue that arises during the process of economically forming the features on the substrate 23 surface, such as the fluid channels (e.g., protrusions 181) is that the features commonly contain facets or other defect regions that lead to areas of incomplete coating coverage and corrosion of the substrate 23 during the operation of the fuel cell. FIG. 4A illustrates a cross-sectional view of a protrusion 181 that has one type of facet, or other defect regions, (e.g., defect 400) that may be formed on the surface of the substrate 23. In this case the defect 400 is a reentrant type feature formed in the profile of the protrusion 181. These type of defects are often hard to completely cover using conventional deposition techniques and often require expensive processes and materials to assure that the substrate is protected. An example of a typical problem found when using a line of sight deposition processes, such as physical vapor deposition (PVD) process, is shown in FIG. 4B. The voids 402, as shown in FIG. 4B, are formed in the coating 401 due to the coating process's inability to adequately cover the defects 400 and thus protect the substrate 23 from attack when in a corrosive environment.

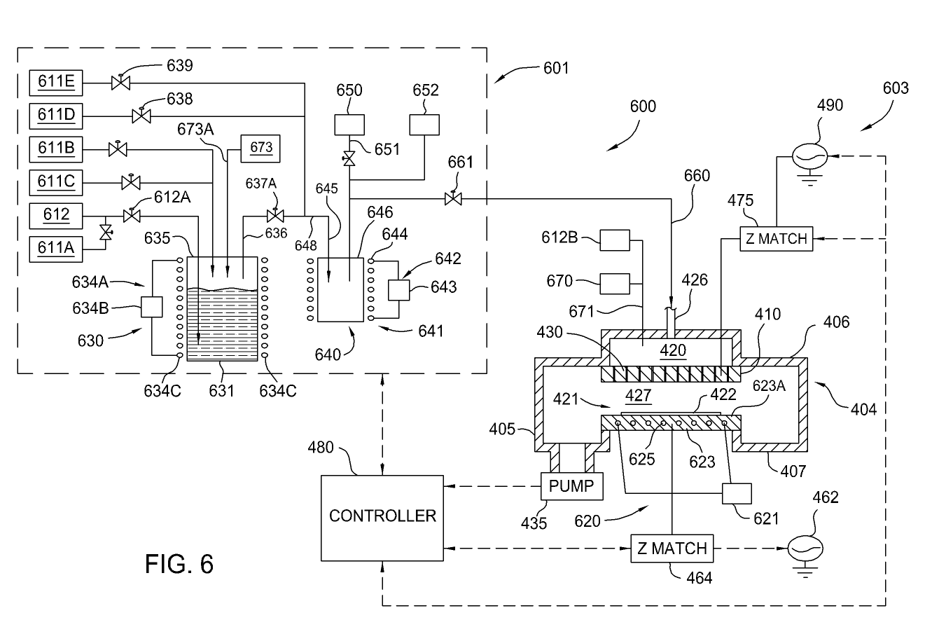

Therefore, as shown in FIG. 5, a coating 20 that completely protects the surface of the substrate 23, and that is inexpensive to deposit is required. It should be noted that the phrase “inexpensive to deposit” as used herein is meant to generally describe both the coating's material cost and the cost to perform the deposition process. In general a conformal coating is needed to be formed over the surface of the substrate 23 to prevent the aggressive components in the fuel cell from attacking the substrate material. It should be noted that the coating 20 when used as part of the bipolar plate 180 needs to adhere to the substrate surface, have a low electrical resistivity (high conductivity), have good resistance to chemical attack, and be relatively inexpensive to deposit. In general, since the coating 20 is used to form a corrosion resistant layer that may be used to form a current carrying layer and/or a good electrical contact to the anode catalyst region 120 or the cathode catalyst region 130 of the MEA, metals, such as ruthenium, rhodium, palladium, osmium, iridium, tantalum, and platinum and noble metals (e.g., gold, silver) may be used.

In one embodiment, the coating 20 contains a ruthenium (Ru) containing layer that is conformally coated over the surface of the substrate. It has been found that a coating 20 that contains a layer of ruthenium is advantageous to protect the surface of the substrate from attack from the chemically aggressive components in the fuel cell. In one example, a 30 angstrom (Å) pure ruthenium layer was deposited on a silicon substrate and then exposed to an aqueous solution containing about 85 wt % of phosphoric acid at a temperature of about 180° C. for about <2 hours. In this experiment a doped silicon substrate being about 0.775 mm thick was completely etched away from the unprotected backside of the substrate while the 30 Å ruthenium layer showed no signs of chemical attack. Typical corrosion results have been compiled below in Table 1 to show the advantages of using a ruthenium coating to prevent attack during the operation of a PAFC. The tests were performed by exposing various coupons to a boiling 85 wt % phosphoric acid solution at a temperature of about 180° C. It should be noted that while the testing was completed to simulate the use of a silicon containing substrate in a phosphoric acid fuel cell it is believed that ruthenium coatings deposited on any type of substrate material will achieve similar results when used in a PAFC.

TABLE 1
Corrosion Results of Various Films

| | First Layer | | | |
|---|---|---|---|---|
| | (adhesion | Second | Third | |
| Substrate | layer) | Layer | Layer | Results |
| Silicon (Si) | 500 Å NiB | — | — | NiB layer removed <5 min. |
| Silicon (Si) | 50 Å NiSi | 450 Å NiB | — | Attack of Si <10 min. |
| Silicon (Si) | 30 Å Ta | 50 Å TaN | — | Attack of Si <10 min. |
| Silicon | 100 Å W | 30 Å Ta | 50 Å TaN | Attack of W <10 min. and attack |
| (Si)/SiO₂ | | | | of Si <40 min. |
| Silicon | 30 Å Ta | 150 Å TaN | — | Attack of SiO₂ through the |
| (Si)/SiO₂ | | | | Ta/TaN <20 min. and attack of Si |
| | | | | <30 min. |
| Silicon (Si) | 50 Å Ti | 50 Å TiN | — | Attack of Si <20 min. |
| Silicon (Si) | 50 Å Ti | 50 Å TiN | 30 Å Ru | No effect after >1 hour |
| Silicon (Si) | 100 Å | — | — | No effect after >1 hour |
| | 90% Ru:10% Ta | | | |
| Silicon (Si) | 50 Å Ta | 50 Å TaN | 50 Å Cu | Attack of SiO₂ through Ta/TaN |
| | | | | <10 min. and attack of Si <20 min. |

The results contained in Table 1 illustrate that metals, such as nickel, tungsten, tantalum, tantalum nitride, titanium and titanium nitride are not suitable to prevent corrosion of the substrate in the high temperature phosphoric acid environment (e.g., PAFC environment), while a thin ruthenium containing coating over various non-corrosion resistant coatings prevented these layers from being attacked. It should be noted that the teachings described herein may also be useful for other types of fuel cells, which may include solid oxide fuel cell (SOFC), molten carbonate fuel cell (MCFC), direct methanol fuel cell (DMFC), polymer electrolyte membrane fuel cell (PEMFC), alkaline fuel cell (AFC), among others.

Ruthenium has many advantages as a protective coating, since it can be inexpensively deposited (discussed below), the material cost is relatively low compared to other chemically inert coating materials, such as gold (Au), platinum (Pt), palladium (Pd), rhodium (Rh), and iridium (Ir), and it has a good electrical conductivity and hardness. Table 2, shown below, lists the properties and costs of typical metals that may be used as a coating 20. The fact that a thin ruthenium coatings (e.g., 30 Å) is able to protect the substrate and underlying layers, thus allows inexpensive and non-chemically inert materials, such as titanium (Ti), nickel (Ni) or stainless steel to be reliably used under the deposited ruthenium layer. In this configuration a non-chemically inert substrate and/or non-chemically inert underlying layer may be used as the fuel cell's current carrying layer to electrically connect the various stacked cells, while being protected from chemical attack due to the protective upper layer containing a thin ruthenium (Ru) layer. In applications that employ strong mineral acid electrolytes, such as sulfuric acids (H₂SO₄) or phosphoric acids (H₂PO₄), it is believed that RuO₂ surfaces exhibit fast reversible redox behavior thought to involve protonation/deprotonation and electron transfer at the electrode double layer. In fact RuO₂ exhibits metallic (electrical) conductivity and may catalyze reactions of molecular oxygen at fuel cell operating temperatures (e.g., 160° C.). Ruthenium dioxide, and ruthenium, are thus attractive as a catalytically active cathode materials that can be applied using a CVD type process over the high surface area gas diffusion layer regions in the anode catalyst region 120 and cathode catalyst region 130 of the membrane 110.

TABLE 2
Material Properties and Typical Commodity Prices

| | | Cost | Resistivity | Hardness |
|---|---|---|---|---|
| Element | Symbol | (US $/oz.) | (nΩ-m) | (Mohs) |
| Silver | Ag | 11.64 | 15.9 | 2.5 |
| Copper | Cu | 0.05 | 16.8 | 3.0 |
| Gold | Au | 585 | 22.1 | 2.5 |
| Rhodium | Rh | 4,030 | 43.3 | 6.0 |
| Iridium | Ir | 335 | 47.1 | 6.5 |
| Nickel | Ni | 0.34 | 69.9 | 4.0 |
| Ruthenium | Ru | 165 | 71.0 | 6.5 |
| Osmium | Os | 400 | 81.2 | 7.0 |
| Palladium | Pd | 337 | 105 | 4.8 |
| Platinum | Pt | 1,077 | 106 | 3.5 |
| Tantalum | Ta | 2.15 | 131 | 6.5 |
| Titanium | Ti | 0.06 | 420 | 6.0 |

In one embodiment, the coating 20 contains a multilayer stack of materials that are deposited on the surface of the substrate 23. FIG. 2 illustrates one embodiment where the coating 20 disposed on the substrate 23 comprises three layers (i.e., layer 25, layer 26 and layer 27). While FIG. 2 illustrates a configuration that contains three layers this configuration is not intended to limiting as to the scope of the invention, since the coating 20 need only contain enough layers to facilitate the electrical contact between the bipolar plate and the MEA, facilitate the transfer of electricity through the fuel cell, and provide resistance to chemical attack of the substrate and/or underlying layers. Typical materials that may be used to form one or more of the layers contained in the coating 20 are, for example, ruthenium (Ru), titanium (Ti), nickel (Ni), cobalt (Co), titanium nitride (TiN), platinum (Pt), palladium (Pd), tantalum (Ta), tantalum nitride (TaN), iridium (Ir), molybdenum (Mo), osmium (Os), rhodium (Rh) and rhenium (Re). Examples of multilayer stacks that may be used to form a coating 20 that contains a ruthenium (Ru) containing layer that have desirable corrosion resistant properties include, but are not limited to layers containing Ti/TiN/Ru, Ti/Ru, Ni/Ru, Ni/Ru/Au, Ni/Ru/Pt, TiN/Ru, Ta/Ru, Ta/TaN/Ru, TaN/Ta/Ru, Ti/TiN/Ru/Pt, Ti/Ru/Pt, Ni/Ru/Pt, Ti/Ru/Pt, Ta/Ru/Pt, Ta/TaN/Ru/Pt, Ti/TiN/Ru/Au, Ti/Ru/Au, Ni/Ru/Au, Ti/Ru/Au, Ta/Ru/Au, Ta/TaN/Ru/Au, Ti/Ru/Au/Pt, Ta/Ru/Au/Pt, and Ti/TiN/Ru/Au/Pt. In one aspect, the coating 20 contains a ruthenium containing layer that is between about 5 Å and about 10,000 Å thick. The nomenclature used herein to define a multilayer stack is intended to describe a coating 20 that contains discrete layers that may be arranged so that the leftmost layer is the bottom layer (i.e., contacts the substrate) and the right most layer is the top layer. For example, a Ti/TiN/Ru stack contains three layers, which are a titanium (Ti) containing layer, a titanium nitride (TiN) containing layer, and a ruthenium (Ru) containing layer (e.g., pure Ru, 0.9Ru:0.1Ta, etc.), that are arranged so that the Ti containing layer is deposited on the substrate 23 and then the TiN containing layer is deposited on the Ti layer and then the Ru containing layer is deposited over both layers. The top layer of the coating 20 will generally contain a layer that will not be chemically attacked by the aggressive species contained or generated in the fuel cell. The multilayer stacks that may be used to form a coating 20 may be deposited by use of one or more conventional deposition techniques, such as physical vapor deposition (PVD), chemical vapor deposition (CVD), plasma enhanced chemical vapor deposition (PECVD), atomic layer deposition (ALD), plasma enhanced atomic layer deposition (PEALD), electrochemical deposition (ECP), or electroless deposition processes. In one aspect, the total thickness of the coating 20 is between about 10 and about 10,000 angstroms (Å).

In one embodiment, a conformal adhesion layer 25 (FIG. 2) is deposited on the surface of the substrate 23 by use of an electroless deposition process, an electrochemical deposition process (e.g., substrate 23 is conductive), a CVD deposition process or an ALD deposition process. The adhesion layer 25 may be used as a diffusion barrier for subsequently deposited layers (e.g., layers 26, 27 in FIG. 2), as a layer that promotes the adhesion of subsequently deposited layers to the substrate 23, acts as a stable electrical contact layer, and/or a conformal catalytic layer to promote the deposition of subsequent layers. In general, the adhesion layer 25 will contain a metal that is known to provide a good electrical contact to the substrate that adheres well to the substrate material and/or is thermally stable at the fuel cell processing temperatures. For example, the adhesion layer 25 may contain metals, such as, titanium (Ti), nickel (Ni), tantalum (Ta), cobalt (Co), tungsten (W), molybdenum (Mo), platinum (Pt), palladium (Pd), iridium (Ir), molybdenum (Mo), and combination thereof. In one embodiment, the adhesion layer 25 is formed on the surface of the substrate using a conventional CVD or ALD type process that are available from Applied Materials Inc., of Santa Clara, Calif. In another embodiment, the adhesion layer 25 is formed on the surface of the substrate using a PVD type process, such as a SIP chamber available from Applied Materials Inc.

In another aspect, the adhesion layer 25 may be formed by use of an electroless deposition process to deposit a binary or ternary alloy, such as cobalt boride (CoB), cobalt phosphide (CoP), nickel boride (NiB), nickel phosphide (NiP), cobalt tungsten phosphide (CoWP), cobalt tungsten boride (CoWB), nickel tungsten phosphide (NiWP), nickel tungsten boride (NiWB), cobalt molybdenum phosphide (CoMoP), cobalt molybdenum boride (CoMoB), nickel molybdenum phosphide (NiMoB), nickel molybdenum phosphide (NiMoP), nickel rhenium phosphide (NiReP), nickel rhenium boride (NiReB), cobalt rhenium boride (CoReB), cobalt rhenium phosphide (CoReP), derivatives thereof, or combinations thereof. An example of an electroless deposition processes used to form a cobalt alloy or nickel alloy layer, such as CoB, CoP, CoWP, CoWB, CoMoP, CoMoB, CoReB, CoReP, NiB, NiP, NiBP, NiWP, or NiWB is further described in the U.S. patent application Ser. No. 11/385,290 [APPM 9916], filed Mar. 20, 2006, the copending U.S. patent application Ser. No. 11/040,962 [APPM 8926], filed Jan. 22, 2005, the copending U.S. patent application Ser. No. 10/967,644 [APPM 8660], filed Oct. 15, 2004, and the copending U.S. patent application Ser. No. 10/967,919 [APPM 8660.02], filed Oct. 18, 2004, which are all incorporated by reference herein in their entirety.

In one example, an electroless solution for depositing nickel boride phosphide (NiBP) containing adhesion layer 25 contains: nickel sulfate with a concentration in a range from about 36 mM to about 44 mM; DMAB with a concentration in a range from about 23 mM to about 27 mM; citric acid with a concentration in a range from about 41 mM to about 49 mM; lactic acid with a concentration in a range from about 62 mM to about 73 mM; glycine with a concentration in a range from about 16 mM to about 20 mM; boric acid with a concentration in a range from about 1 mM to about 4 mM; 0.5 M tetramethylammonium hypophosphorous acid in a range from about 9 mM to about 11 mM; and TMAH with a concentration to adjust the electroless solution to a have pH value in a range from about 9 to about 10, such as about 9.2. The electroless deposition process may be conducted at a temperature within a range from about 35° C. to about 100° C., more preferably from about 75° C. to about 80° C. The “water” component may be degassed, preheated and/or deionized water. Degassing the water reduces the oxygen concentration of the subsequently formed electroless solution. An electroless solution with a low oxygen concentration (e.g., less than about 100 ppm) may be used during the deposition process. Preheated water allows forming the electroless solution at a predetermined temperature just below the temperature used to initiate the deposition process, thereby shortening the process time.

After the conformal adhesion layer 25 is deposited on the surface of the substrate 23, one or more layers can be deposited thereon to protect the adhesion layer 25 and substrate 23 from chemical attack, promote the adhesion of subsequently deposited layers, act as a current carrying layer, and/or provide an electrical contact promoting surface to connect the bipolar plate 180 to the anode catalyst region 120 or the cathode catalyst region 130. In one embodiment, the coating 20 contains two layers that are deposited over the substrate 23 surface. In one aspect, the coating 20 is titanium/ruthenium (Ti/Ru) layer stack where the adhesion layer 25 is a titanium containing layer having a thickness between about 10 Å and about 5,000 Å and a top layer containing ruthenium having a thickness between about 10 Å and about 5,000 Å. In another aspect, the coating 20 is nickel/ruthenium (Ni/Ru) layer stack where the adhesion layer 25 is a nickel containing layer (e.g., Ni, NiB, NiP, NiBP) having a thickness between about 10 Å and about 5,000 Å and a top layer containing ruthenium having a thickness between about 10 Å and about 5,000 Å. In another aspect, the coating 20 is tantalum/ruthenium (Ta/Ru) layer stack where the adhesion layer 25 is a tantalum containing layer having a thickness between about 10 Å and about 5,000 Å and a top layer containing ruthenium having a thickness between about 10 Å and about 5,000 Å. In this configuration, the ruthenium containing layer is adapted to protect the underlying adhesion layer 25 and the substrate 23, act as a current carrying layer, and/or provide a reliable electrical contact between the bipolar plate 180 to the anode catalyst region 120 or the cathode catalyst region 130.

In another embodiment, the coating 20 contains three layers that are adapted to protect the substrate 23 from chemical attack, promote the adhesion of subsequently deposited layers, act as a current carrying layer, and/or provide an electrical contact promoting surface to connect the bipolar plate 180 to the anode catalyst region 120 or the cathode catalyst region 130. In one aspect, the coating 20 contains an adhesion layer 25, an intermediate ruthenium containing layer having a thickness between about 10 Å and about 5,000 Å, and an electrical contact layer (e.g., layer 27) disposed on the intermediate ruthenium containing layer. In one aspect, the adhesion layer 25 is a metal selected from group consisting of ruthenium (Ru), titanium (Ti), nickel (Ni), cobalt (Co), titanium nitride (TiN), platinum (Pt), palladium (Pd), tantalum (Ta), tantalum nitride (TaN), iridium (Ir), molybdenum (Mo), osmium (Os), rhodium (Rh), rhenium (Re), and combination thereof, that is between about 10 Å and about 5,000 Å thick. In one aspect, the uppermost, electrical contact layer (e.g., layer 27), is a metal selected from group consisting of gold (Au), platinum (Pt), palladium (Pd), rhodium (Rh), iridium (Ir), and combinations thereof, that has a deposited thickness between about 5 Å and about 10,000 Å. This configuration may be advantageous, since the uppermost layer (e.g., Au, Pt) may form a good electrical contact, due to its malleability and oxidation characteristics, while the ruthenium layer provides a corrosion resistant layer that has good mechanical properties (e.g., hardness, abrasion resistance). Conventional deposition techniques used to deposit metals, such as gold (Au), platinum (Pt), and palladium (Pd) are not able to form a reliable and/or robust coating that can be used to prevent the attack of the substrate 23, because the deposited films generally contain pores, holes or other types of discontinuities. It is also believed that the pressure exerted to create a contact between the MEA and the surface of the bipolar, unipolar or end plates can result in penetration and/or hole formation in the uppermost layer of the coating 20. It is believed that this problem is more prevalent in the softer coating materials, such as gold, silver and platinum. Therefore, it is believed that by adding a layer within the coating 20 that is relatively hard, such as ruthenium, these types of failures can be prevented. In one embodiment, the electrical contact layer is generally used to act as a current carrying layer and/or provide a reliable electrical contact between the bipolar plate 180 to the anode catalyst region 120 or the cathode catalyst region 130, while the intermediate ruthenium containing layer is adapted to protect the underlying adhesion layer 25 and the substrate 23.

In one aspect, it may be desirable to anneal the coating 20 deposited on the surface of the substrate 23 to promote the bonding of the adhesion layer 25 to the substrate 23 and/or reduce the stress in the deposited films. In one aspect, where the substrate 23 is a silicon containing substrate an anneal process may be completed at a high enough temperature to promote the formation of a silicide layer between the adhesion layer 25 and the substrate 23. In this case, the adhesion layer 25 may be a nickel, cobalt, molybdenum, tungsten, titanium or tantalum containing layer to form a nickel silicide (NiSiₓ), cobalt silicide (CoSiₓ), tungsten silicide (WSiₓ), molybdenum silicide (MoSi), titanium silicide (TiSiₓ) or tantalum silicide (TaSiₓ), respectively.

### Ruthenium Containing Layer Formation Process and Deposition Apparatus

As noted above two key aspects in creating a production worthy fuel cell is developing a fuel cell fabrication process that minimizes the cost to produce a fuel cell and that forms a fuel cell that has a desirable lifetime/reliability. As discussed above, one way to meet these goals is to inexpensively form a ruthenium containing layer to protect the surface of the substrate. One such method described herein is adapted to selectively or non-selectively deposit a ruthenium containing layer on a surface of a substrate 23 by use of a ruthenium tetroxide containing gas. It is believed that the selective or non-selective deposition of a ruthenium containing layer on the surface of the substrate is strongly dependent on the temperature and type of surfaces that are exposed to the ruthenium tetroxide containing gas. It is also believed that by controlling the temperature below, for example about 180° C., a ruthenium layer can selectively deposit on certain types of surfaces. At higher temperatures, for example greater than 180° C., the ruthenium deposition process from a ruthenium tetroxide containing gas becomes much less selective and thus will allow a blanket film to deposit on all types of surfaces.

In one aspect, the properties of the ruthenium containing layer deposited on the surface of the substrate is specially tailored to provide a protective layer over the surface of the substrate. Typical desirable properties may include the formation of crystalline or amorphous metallic ruthenium layers on the surface of the substrate. Another desirable feature of using a ruthenium tetroxide deposition process is the ability to form a ruthenium dioxide layer (RuO₂) on the surface of the substrate or MEA to, for example, act as a catalyst for fuel cell reactions and/or electrical conductor. In one embodiment, ruthenium tetraoxide is used to form the MEA structure prior to installation in the fuel cell. In this configuration ruthenium tetroxide is delivered to a processing chamber that has an MEA disposed therein to coat the anode catalyst region 120 or the cathode catalyst region 130 surfaces of the MEA. In another embodiment, ruthenium tetraoxide is delivered to the fluid channels in a fully assembled fuel cell to provide a coating the anode catalyst region 120 or the cathode catalyst region 130 surfaces of the MEA (discussed below).

An example of various inexpensive methods of forming ruthenium tetraoxide to be used to deposit a layer on a substrate surface is further described in the U.S. patent application Ser. No. 11/228,425 [APPM 9906], filed Sep. 15, 2005, which is herein incorporated by reference in its entirety. An example of one method used to form ruthenium tetraoxide and deposit a ruthenium containing layer is discussed below. An exemplary apparatus and method of forming a ruthenium tetroxide containing gas to form a ruthenium containing layer on a surface of a substrate is described herein.

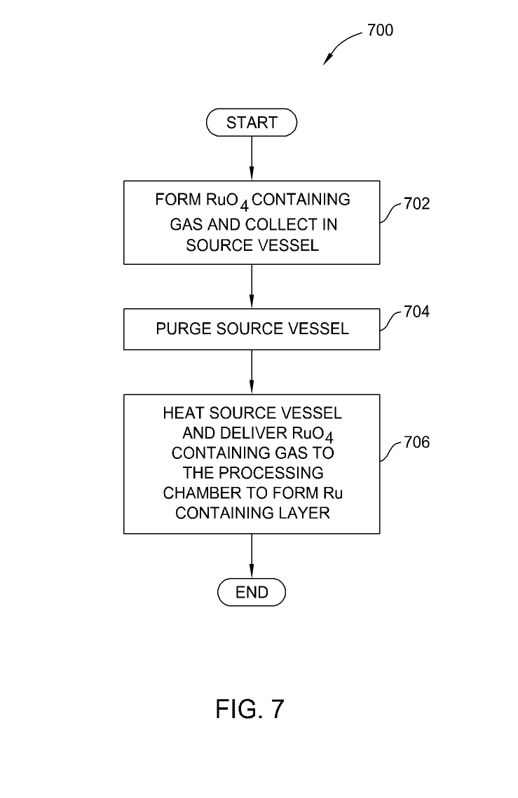

FIG. 6 illustrates one embodiment of a deposition chamber 600 that can be adapted to generate and deposit a ruthenium containing layer on a surface of a substrate. In one embodiment, the ruthenium containing layer is formed on a surface of a substrate by creating ruthenium tetroxide in an external vessel and then delivering the generated ruthenium tetroxide gas to a surface of a temperature controlled substrate positioned in a processing chamber.

In one embodiment, a ruthenium tetroxide containing gas is generated, or formed, by passing an ozone containing gas across a ruthenium source that is housed in an external vessel. In one aspect, the ruthenium source is maintained at a temperature near room temperature. In one aspect, the ruthenium source contains an amount of ruthenium metal (Ru) which reacts with the ozone. In one aspect, the metallic ruthenium source contained in the external vessel is in a powder, a porous block, or solid block form.

In another aspect, the ruthenium source housed in the external vessel contains an amount of a perruthenate material, such as sodium perruthenate (NaRuO₄) or potassium perruthenate (KRuO₄) which will react with the ozone, likely according to reaction (1) or (2), to form ruthenium tetroxide (RuO₄) a compound that is volatile at the reaction conditions.

2NaRuO₄+O₃+H₂O→RuO₄+2NaOH+Na₂O+O₂ (1)

2KRuO₄+O₃+H₂O→RuO₄+2KOH+K₂O+O₂ (2)

It should be noted that the list of materials shown here are not intended to be limiting, and thus any material that upon exposure to ozone or other oxidizing gases forms a ruthenium tetroxide containing gas may be used without varying from the basic scope of the invention. To form the various ruthenium source materials used in the external vessel, various conventional forming processes may be used.

The deposition chamber 600 generally contains a process gas delivery system 601 and a processing chamber 603. FIG. 6 illustrates one embodiment of a processing chamber 603 that may be adapted to deposit the ruthenium containing layers on the surface of a substrate. In one aspect, the processing chamber 603 is a processing chamber 603 that may be adapted to deposit a adhesion layer 25 on the surface of the substrate by use of a CVD, ALD, PECVD or PE-ALD process prior to depositing a ruthenium containing layer on the surface of the substrate 23. In another aspect, the processing chamber 603 is adapted to primarily deposit the ruthenium containing layer and thus any prior or subsequent device fabrication steps are performed in other processing chambers. The use of a vacuum processing chamber during processing can be advantageous, since processing in a vacuum condition can reduce the amount of contamination that can be incorporated in the deposited film. Vacuum processing will also improve the diffusion transport process of the ruthenium tetroxide to the surface of the substrate and tend to reduce the limitations caused by convective type transport processes.

The processing chamber 603 generally contains a processing enclosure 404, a showerhead 410, a temperature controlled substrate support 623, and the process gas delivery system 601 connected to the inlet line 426 of the processing chamber 603. The processing enclosure 404 generally contains a sidewall 405, a ceiling 406 and a base 407 enclose the processing chamber 603 and form a process area 421. A substrate support 623, which supports a substrate 422 on a supporting surface 623A, mounts to the base 407 of the processing chamber 603. In one embodiment of the deposition chamber 600, the substrate support 623 is heated and/or cooled by use of a heat exchanging device 620 and a temperature controller 621, to improve and control properties of the ruthenium layer deposited on the substrate 422 surface. In one aspect, the heat exchanging device 620 is a fluid heat exchanging device that contains embedded heat transfer lines 625 that are in communication with a temperature controller 621 which controls the heat exchanging fluid temperature. In another aspect, the heat exchanging device 620 is a resistive heater, in which case the embedded heat transfer lines 625 are resistive heating elements that are in communication with the temperature controller 621. In another aspect, the heat exchanging device 620 is a thermoelectric device that is adapted to heat and cool the substrate support 623. A vacuum pump 435, such as a turbo-pump, cryo-turbo pump, roots-type blower, and/or rough pump, controls the pressure within the processing chamber 603. The showerhead 410 consists of a gas distribution plenum 420 connected to the inlet line 426 and the process gas delivery system 601. The inlet line 426 and process gas delivery system 601 are in communication with the process region 427 over the substrate 422 through plurality of gas nozzle openings 430.

In one aspect of the invention it may be desirable to generate a plasma during the deposition process to improve the deposited ruthenium containing layer's properties. In this configuration, the showerhead 410, is made from a conductive material (e.g., anodized aluminum, etc.), which acts as a plasma controlling device by use of the attached to a first impedance match element 475 and a first RF power source 490. A bias RF generator 462 applies RF bias power to the substrate support 623 and substrate 422 through an impedance match element 464. A controller 480 is adapted to control the impedance match elements (i.e., 475 and 464), the RF power sources (i.e., 490 and 462) and all other aspects of the plasma process. The frequency of the power delivered by the RF power source may range between about 0.4 MHz to greater than 10 GHz. In one embodiment dynamic impedance matching is provided to the substrate support 623 and the showerhead 410 by frequency tuning and/or by forward power serving. While FIG. 6 illustrates a capacitively coupled plasma chamber, other embodiments of the invention may include inductively coupled plasma chambers or combination of inductively and capacitively coupled plasma chambers with out varying from the basic scope of the invention.

In one embodiment, the processing chamber 603 contains a remote plasma source (RPS) (element 670 in FIG. 6) that is adapted to deliver various plasma generated species or radicals to the processing region 427 through an inlet line 671. An RPS that may be adapted for use with the deposition chamber 600 is an Astron® Type AX7651 reactive gas generator from MKS ASTeX® Products of Wilmington, Mass. The RPS is generally used to form, reactive components, such as hydrogen (H) radicals, which are introduced into the processing region 427. The RPS thus improves the reactivity of the excited gas species to enhance the reaction process. A typical RPS process may include using 1000 sccm of H₂ and 1000 sccm of argon and an RF power of 350 Watts and a frequency of about 13.56 MHz. In one aspect a forming gas, such as a gas containing 4% H₂ and the balance nitrogen may be used. In another aspect a gas containing hydrazine (N₂H₄) may be used. In general, the use of plasma excitation to generate reducing species capable of converting RuO₂ to Ru will allow this reaction to proceed at lower temperatures. This process may be most useful when it is desired to deposit the RuO₂ selectively, generally below approximately 180° C. and then subsequently perform the reduction to metallic ruthenium at the same temperature and/or in the same chamber.

In one embodiment of the deposition chamber 600, a process gas delivery system 601 is adapted to deliver a ruthenium containing gas, or vapor, to the processing region 427 so that a ruthenium containing layer can be formed on the substrate surface. The process gas delivery system 601 generally contains one or more gas sources 611A-E, an ozone generator 612, a processing vessel 630, a source vessel assembly 640 and an outlet line 660 attached to the inlet line 426 of the processing chamber 603. The one or more gas sources 611A-E are generally sources of various carrier and/or purge gases that may be used during processing in the processing chamber 603. The one or more gases delivered from the gas sources 611A-E may include, for example, nitrogen, argon, helium, hydrogen, or other similar gases.

Typically, the ozone generator 612 is a device which converts an oxygen containing gas from an gas source (not shown) attached to the ozone generator 612 into a gas containing between about 4 wt. % and about 100 wt. % of ozone (O₃), with the remainder typically being oxygen. Preferably, the concentration of ozone is between about 6 wt. % and about 100 wt. %. It should be noted that forming ozone in concentrations greater than about 15% will generally require a purification process that may require a process of adsorbing ozone on a cold surface in a processing vessel and then purging the vessel using an inert gas to remove the contaminants. However, the ozone concentration may be increased or decreased based upon the amount of ozone desired and the type of ozone generating equipment used. A typical ozone generator that may be adapted for use with the deposition chamber 600 are the Semozon® and Liquozon® Ozone generators that can be purchased from MKS ASTeX® Products of Wilmington, Mass. The gas source 611A may be adapted to purge or as a carrier gas to deliver the ozone generated in the ozone generator 612 to the input port 635 of the processing vessel 630.

In one embodiment of the process gas delivery system 601, the processing vessel 630 contains a vessel 631, a temperature controlling device 634A, an input port 635 and an output port 636. The vessel 631 is generally an enclosed region made of or coated with glass, ceramic or other inert material that will not react with the processing gas formed in the vessel 631. In one aspect, the vessel 631 contains a volume of a ruthenium source (e.g., ruthenium metal, sodium perruthenate; see element “A”), preferably in a porous-solid, powder, or pellet form, to promote the formation of ruthenium tetroxide when the ozone gas is delivered to the vessel 631. The temperature controlling device 634A generally contains a temperature controller 634B and a heat exchanging device 634C, which are adapted to control the temperature of the vessel 631 at a desired processing temperature during the ruthenium tetroxide generation process. In one aspect, the heat exchanging device 634C is a temperature controlled fluid heat exchanging device, a resistive heating device and/or a thermoelectric device that is adapted to heat and/or cool the vessel 631 during different phases of the process.

In one embodiment, a remote plasma source 673 is connected to the processing vessel 630 via the RPS inlet line 673A so that in different phases of the ruthenium tetroxide formation process the ruthenium source can be regenerated by injecting hydrogen (H) radicals into the vessel 631 to reduce any formed oxides on the surface of the ruthenium source. Regeneration may be necessary when an undesirable layer of ruthenium dioxide (RuO₂) is formed on a significant portion of the exposed ruthenium source contained in the vessel 631. In one embodiment, the regeneration process is performed when by introducing a hydrogen containing gas to the ruthenium source that has been heated to an elevated temperature in an effort to reduce the formed oxides.

In another embodiment, ruthenium tetroxide is formed using an aqueous hypochlorite solution. The first step of the ruthenium tetroxide formation process starts by first dissolving a ruthenium powder in an aqueous solution in a first vessel that contains sodium hypochlorite heated to 60° C. In one aspect, the process solution may be formed by dissolving ruthenium metal in a solution of excess sodium hypochlorite (NaOCl) followed by titration with sulfuric acid to a pH value near 7 to liberate ruthenium tetroxide. One will note that hypochlorite materials, such as potassium or calcium hypochlorite, may also be used in place of the sodium hypochlorite. The ruthenium tetroxide is likely formed according to reaction (3).

Ru(metal)+4NaOCl→RuO₄+4NaCl (3)

In one example, a process solution was formed by mixing 50 ml of a sodium hypochlorite (e.g., 10% NaOCl solution) with 1 gram of finely powdered ruthenium metal and stirring until dissolution is essentially complete. A sufficient amount of 10% solution of H₂SO₄ in water was then added to achieve a pH of about 7. In general, any acid that is non-oxidizable and non-volatile can be used in place of the sulfuric acid, such as phosphoric acid (H₃PO₄). An example of a method of forming ruthenium tetroxide using hypochlorite is further described in the U.S. patent application Ser. No. 11/228,425 [APPM 9906], filed Sep. 15, 2005, which is herein incorporated by reference in its entirety.

Referring to FIG. 6, the source vessel assembly 640 generally contains a source vessel 641, a temperature controller 642, an inlet port 645 and an outlet port 646. The source vessel 641 is adapted to collect and retain the ruthenium tetroxide generated in the processing vessel 630. The source vessel 641 is generally lined, coated or made from a glass, ceramic, plastic (e.g., Teflon, polyethylene, etc.), or other material that will not react with the ruthenium tetroxide and has desirable thermal shock and mechanical properties. When in use the temperature controller 642 cools the source vessel 641 to a temperature less than about 20° C. to condense the ruthenium tetroxide gas on to the walls of the source vessel. The temperature controller 642 generally contains a temperature controller device 643 and a heat exchanging device 644, which are adapted to control the temperature of the source vessel 641 at a desired processing temperature. In one aspect, the heat exchanging device 644 is a temperature controlled fluid heat exchanging device, a resistive heating device and/or a thermoelectric device that is adapted to heat and cool the source vessel 641.

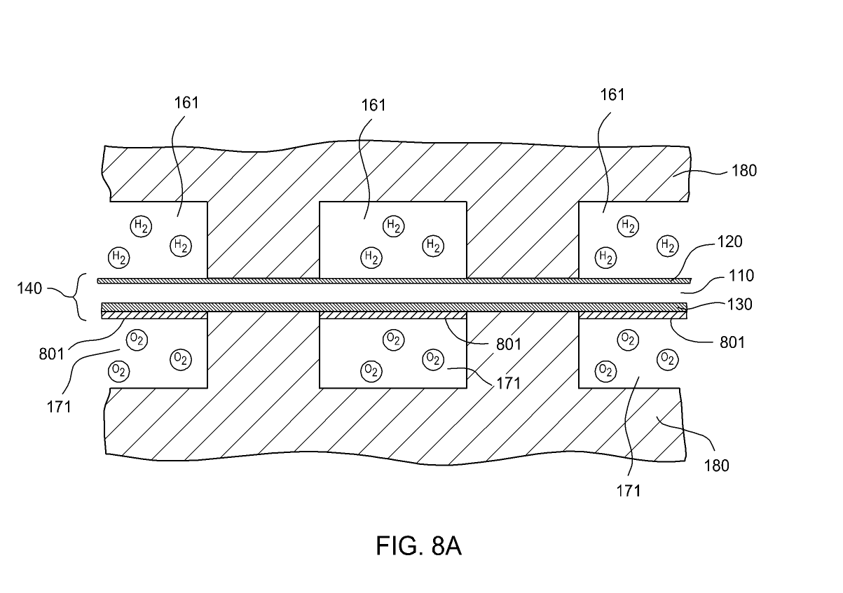

FIG. 7 depicts process 700 according to one embodiment described herein for forming a ruthenium containing layer on a surface of a substrate. Process 700 includes steps 702-706, wherein a ruthenium containing layer is directly deposited on surface of a substrate. The first process step 702 of process 700 includes step of forming a ruthenium tetroxide gas and collecting the generated gas in the source vessel 641. In process step 702, ozone generated in the ozone generator 612 is delivered to the ruthenium source contained in the processing vessel 631 to form a flow of a ruthenium tetroxide containing gas, which is collected in the source vessel 641. Therefore, during process step 702 an ozone containing gas flows across the ruthenium source which causes ruthenium tetroxide to be formed and swept away by the flowing gas. During this process the gas flow path is from the ozone generator 612, in the inlet port 635, across the ruthenium source (item “A”), through the outlet port 636 in the vessel 631 through the process line 648 and into the closed source vessel 641. In one embodiment, it may be desirable to evacuate the source vessel 641 using a conventional vacuum pump 652 (e.g., conventional rough pump, vacuum ejector), prior to introducing the ruthenium tetroxide containing gas. In one aspect, the gas source 611A is used to form an ozone containing gas that contains pure oxygen and ozone or an inert gas diluted oxygen containing gas and ozone. In one aspect of process step 702, the ruthenium source (item “A”) contained in the vessel 631 is maintained at a temperature between about 0° C. and about 100° C., and more preferably between about 20° C. and about 60° C. to enhance the ruthenium tetroxide formation process in the vessel 631. While a lower ruthenium tetroxide generation temperature is generally desirable, it is believed that the required temperature to form a ruthenium tetroxide gas is somewhat dependent on the amount of moisture contained in the vessel 631 during processing. During process step 702, the source vessel 641 is maintained at a temperature below about 25° C. at pressures that allow the generated ruthenium tetroxide to condensed, or crystallized (or solidified), on the walls of the source vessel 641. For example, the source vessel 641 is maintained at a pressure of about 5 Torr and a temperature between about −20 and about 25° C. By cooling the ruthenium tetroxide and causing it to condense or solidify on the walls of the source vessel 641 the unwanted oxygen (O₂) and ozone (O₃) containing components in the ruthenium tetroxide containing gas can be separated and removed in the second process step 704. In one aspect, it may be desirable to inject an amount of water, or a water containing gas, into the vessel 631 to promote the ruthenium tetroxide generation process. The injection of water may be important to improve the dissociation of the ruthenium tetroxide from the ruthenium source, for example, when ruthenium source contains sodium perruthenate or potassium perruthenate. In one aspect, it may be desirable to remove the excess water by a conventional physical separation (e.g., molecular sieve) process after the dissociation process has been performed.

The second process step 704, or purging step, is designed to remove the unwanted oxygen (O₂) and unreacted ozone (O₃) components from the ruthenium tetroxide containing gas. Referring to FIG. 6, in one embodiment the second process step 704 is completed while the walls of the source vessel 641 are maintained at a temperature of 25° C. or below, by closing the ozone isolation valve 612A and flowing one or more purge gasses from the one or more of the gas sources 611B-C through the processing vessel 630, into the process line 648, through the source vessel 641 and then through the exhaust line 651 to the exhaust system 650. The amount of un-solidified or un-condensed ruthenium tetroxide that is wasted during the completion of process step 704, can be minimized by adding a wait step of a desired length between the process step 702 and process step 704 to allow the ruthenium tetroxide time to condense or solidify. The amount of un-solidified or un-condensed ruthenium tetroxide that is wasted can be further reduced also by lowering the source vessel wall temperature to increase the rate of solidification, and/or increasing the surface area of the source vessel to increase the interaction of the walls and the ruthenium tetroxide containing gas. The purge gases delivered from the one or more gas sources 611B-C can be, for example, nitrogen, argon, helium, or other dry and clean process gas. Since the unwanted oxygen (O₂) and unreacted ozone (O₃) components can cause unwanted oxidation of exposed surfaces on the substrate the process of removing these components can be critical to the success of the ruthenium deposition process. Removal of these unwanted oxygen (O₂) and unreacted ozone (O₃) components is especially important where the materials on which the ruthenium tetroxide is to be eventually delivered is an easily oxidized material, such as copper. Copper, and other materials that have a high affinity for oxygen, will be easily corroded in the presence of these oxidizing species. In one embodiment, the process step 704 is completed until the concentration of oxygen (O₂) and/or unreacted ozone (O₃) is below about 100 parts per million (ppm). In one aspect, it may be desirable to heat the vessel 631 to a temperature between about 20° C. and 25° C. during the process step 704 to assure that all of the formed ruthenium tetroxide has been removed from the processing vessel 630.

In one aspect, the purging process (step 704) is completed by evacuating the source vessel 641 using a vacuum pump 652 to remove the contaminants. To prevent an appreciable amount of ruthenium tetroxide being removed from the source vessel assembly 640 during this step the temperature and pressure of the vessel may be controlled to minimize the loss due to vaporization. For example, it may be desirable to pump the source vessel assembly 640 to a pressure of about 5 Torr while it is maintained at a temperature below about 0° C.

In one embodiment, the third process step 706, or deliver the ruthenium tetroxide to the processing chamber 603 step, is completed after the source vessel 641 has been purged and valve 637A is closed to isolate the source vessel 641 from the processing vessel 630. The process step 706 starts when the source vessel 641 is heated to a temperature to cause the condensed or solidified ruthenium tetroxide to form a ruthenium tetroxide gas, at which time the one or more of the gas sources 611 (e.g., items 611D and/or 611E), the gas sources associated isolation valve (e.g., items 638 and/or 639) and process chamber isolation valve 661 are opened which causes a ruthenium tetroxide containing gas to flow into the inlet line 426, through the showerhead 410, into an process region 427 and across the temperature controlled substrate 422 so that a ruthenium containing layer can be formed on the surface of the substrate 23. In one embodiment, the source vessel 641 is heated to a temperature between about 0° C. and about 50° C. to cause the condensed or solidified ruthenium tetroxide to form a ruthenium tetroxide gas. It should be noted that even at the low temperatures, for example about 5° C., an equilibrium partial pressure of ruthenium tetroxide gas will exist in the source vessel 641. Therefore, in one aspect, by knowing the mass of ruthenium tetroxide contained in the vessel, by knowing the volume and temperature of the source vessel 641, a repeatable mass can be delivered to the processing chamber 603. In another aspect, a continuous flow of a ruthenium tetroxide containing gas can be formed and delivered to the processing chamber 603, by knowing the sublimation or vaporization rate of the ruthenium tetroxide at a given temperature for a given sized source vessel 641 and flowing a carrier gas at a desired rate through the source vessel 641 to form a gas having a desired concentration of ruthenium tetroxide.

In order to deposit a ruthenium containing layer non-selectively on a surface of the substrate, it is believed that at temperatures greater then 180° C. ruthenium tetroxide (RuO₄) is will undergo a spontaneous decomposition to thermodynamically stable ruthenium dioxide (RuO₂), and at slightly higher temperatures in the presence of hydrogen (H₂) the deposition proceeds directly to a desired outcome of forming a metallic ruthenium layer. The balanced equation for the reaction is shown in equation (4).

RuO₄+4H₂ →Ru(metal)+4H₂O (4)

Therefore, in one aspect of the invention, during the process step 706 the substrate surface is maintained, by use of the temperature controlled substrate support 623, at a temperature above about 180° C., and more preferably at a temperature between of about 180° C. and about 450° C., and more preferably a temperature between about 200° C. and about 400° C. To form a metallic ruthenium layer the temperature may be between about 300° C. and about 400° C. Typically the processing chamber pressure is maintained at a pressure below about 10 Torr, and preferably between about 500 millitorr (mT) and about 5 Torr. By controlling the temperature of the surface of the substrate the selectivity of the deposited ruthenium containing layer and crystal structure of the deposited ruthenium containing layer can be adjusted and controlled as desired. It is believed that a crystalline ruthenium containing layer will be formed at temperatures above 350° C.

In one aspect of the process step 706, a the ruthenium tetroxide containing gas is formed when a nitrogen containing gas is delivered from the gas source 611D and a hydrogen (H₂) containing gas (e.g., hydrogen (H₂), hydrazine (N₂H₄)) is delivered from the gas source 611E through the source vessel assembly 640 containing an amount of ruthenium tetroxide and then through the processing chamber 603. For example, 100 sccm of nitrogen and 100 sccm of H₂ gas is delivered to the processing chamber 603 which is maintained at a pressure between about 0.1 and about 10 Torr, and more preferably about 2 Torr. The desired flow rate of the gasses delivered from the gas sources 611 (e.g., items 611D-E) is dependent upon the desired concentration of the ruthenium tetroxide in the ruthenium tetroxide containing gas and the vaporization rate of the ruthenium tetroxide from the walls of the source vessel 641.

In one embodiment, the remote plasma source 670 is utilized during the process step 706 to enhance the process of forming a metallic ruthenium layer. In this case hydrogen radicals generated in the remote plasma source are injected into the processing region 427 to reduce any formed oxides on the surface of the ruthenium deposited on the surface of the substrate. In one aspect the RPS is used to generate hydrogen radicals as the ruthenium tetroxide containing gas is delivered to the processing region 427. In another aspect, the RPS is only used after each successive monolayer of ruthenium has been formed and thus forms a two step process consisting of a deposition step and then a reduction of the ruthenium layer step.

In one embodiment of process step 706, the amount of ruthenium tetroxide gas generated and dispensed in the processing chamber 603 is monitored and controlled to assure that the process is repeatable, complete saturation of the process chamber components is achieved and a desired thickness of the ruthenium containing film has been deposited. In one aspect, the mass of the ruthenium tetroxide delivered to the process chamber is monitored by measuring the change in weight of the source vessel 641 as a function of time, by use of a conventional electronic scale, load cell, or other weight measurement device.

In one embodiment, the gas delivery system 601 is adapted to deliver a single dose, or mass of ruthenium tetroxide, to the processing chamber 603 and the substrate to form a ruthenium containing layer on the surface of the substrate. In another embodiment, multiple sequential doses of ruthenium tetroxide are delivered to the processing chamber 603 to form a multilayer ruthenium containing film. To perform the multiple sequential doses of ruthenium tetroxide, at least one of the process steps 702 through 706, are repeated multiple times to form the multilayer ruthenium containing film. In another embodiment, the surface area of the source vessel 641 and the length of the process step 702 are both sized to allow a continuous flow of a desired concentration of a ruthenium tetroxide containing gas across the surface of the substrate during the ruthenium containing layer deposition process. The gas flow distribution across the surface of the substrates can be important to the formation of uniform layers upon substrates processed in the processing chamber, especially for processes that are dominated by mass transport limited reactions (CVD type reactions) and for ALD type processes where rapid surface saturation is required for reaction rate limited deposition. Therefore, the use of a uniform gas flow across the substrate surface by use of a showerhead 410 may be important to assure uniform process results across the surface of the substrate.

In one aspect of the invention, the process of delivering a mass of ruthenium tetroxide into the processing chamber 603 has advantages over conventional ALD or CVD type processes, because the organic material found in the ALD or CVD precursor(s) are not present in the ruthenium containing gas and thus will not be incorporated into the growing ruthenium containing layer. The incorporation of the organic materials in the growing ruthenium film can have large affect on the electrical resistance, adhesion and the stress migration and electromigration properties of the formed device(s). Also, since the size of the ruthenium tetraoxide molecule is much smaller than the traditional ruthenium containing precursors the ruthenium containing layer deposition rate per ALD cycle using ruthenium tetroxide will be increased over conventional precursors, due to the improved ruthenium coverage per ALD cycle.

In one aspect, the inert gas source 674 and/or the dosing vessel 662 are used to “dose,” or “pulse,” the ruthenium tetroxide containing gas into the process region 427 so that the gas can saturate the surface of the substrate (e.g., an ALD type process). The “dose,” or “dosing process,” may be performed by opening and closing the various isolation valves for a desired period of time so that a desired amount of the ruthenium containing gas can be injected into the processing chamber 603. In one aspect, no inert gas is delivered to the dosing vessel 662, from the gas source 674, during the dosing process.

In yet another one embodiment, a ruthenium tetroxide containing gas can be formed using ruthenium dioxide hydrate (RuO₂.H₂O) that is combined with potassium periodate (KIO₄) and DI water to form ruthenium tetroxide at room temperature. In one example, about 0.3 g of RuO₂ was added to Pyrex® glass bubbler that contains 2.0 g of KIO₄ and 50 ml of DI water at room temperature to form a ruthenium tetroxide containing gas that was entrained in a flow of air that was bubbled through the mixture. In some cases it may be desirable to separate any entrained water vapor in the ruthenium containing gas by use of a conventional physical separation (e.g., molecular sieves), cold trap or other conventional schemes.

It should be noted that one or more of the processes described above can be used to deposit a ruthenium containing layer on all surfaces of the substrate by disposing the substrate in a processing region of a processing chamber and then exposing substrate to the ruthenium tetroxide so that the ruthenium tetroxide envelops all of the surfaces of the substrate. Conventional RF inductive heating may be used to control the temperature of the substrates in the processing region of the processing chamber.

### Ruthenium/Tantalum Layer

In one aspect, one or more of the layers contained in the coating 20 is deposited in by use of a PVD deposition process that is used to deposit a layer that contains two or more elements, such as a ruthenium and tantalum alloy. Ruthenium and Tantalum alloys are useful, since they have the combined benefits of blocking diffusion of the subsequently deposited layers and providing a suitable surface for direct electroless and/or electrochemical plating of the subsequent coating layers thereon. Therefore, in one aspect of the invention, the coating 20 contains a Ru—Ta alloy that contains between about 70 atomic % and about 95 atomic % ruthenium and the balance tantalum. In another aspect, the coating 20 preferably contains a Ru—Ta alloy that contains between about 70 atomic % and about 90 atomic % ruthenium and the balance tantalum. In yet another aspect, the coating 20 more preferably contains a Ru—Ta alloy that contains between about 80 atomic % and about 90 atomic % ruthenium and the balance tantalum. In one aspect, it may be desirable to select a Ru—Ta alloy that does not contain regions of pure tantalum on the surface. In one aspect, a PVD type deposition process is used to deposit a coating 20 that contains the Ru—Ta alloy containing about 90 atomic % ruthenium and the balance tantalum (e.g., 0.9Ru:0.1Ta).

### Deposition Using a Ruthenium Precursor

In one embodiment, it may be desirable to deposit a ruthenium containing layer over the substrate surface by exposing the substrate surface to a conventional ruthenium precursor material commonly used to deposit ruthenium containing layers on semiconductor wafers. The ruthenium layer may be deposited using a cyclical deposition process or conventional CVD type process. The cyclical deposition process comprises alternately adsorbing a ruthenium-containing precursor and a reducing gas on a substrate structure. During processing the ruthenium-containing precursor and a reducing gas (e.g., hydrogen (H₂), ammonia (NH₃)) undergo a reaction to form the ruthenium layer on the substrate. In general, for ruthenium layer deposition, the substrate should be maintained at a temperature less than about 500° C., preferably in a range from about 200° C. to about 400° C., for example, about 300° C. The process chamber pressure during the deposition process may be is maintained in a range from about 0.1 Torr to about 80 Torr. In general some useful ruthenium precursors include, but are not limited to ruthenocene compounds, such as bis(ethylcyclopentadienyl)ruthenium, bis(cyclopentadienyl)ruthenium bis(pentamethylcyclopentadienyl)ruthenium, methylcyclopentadienly pyrrolyl ruthenium, and dicarbonylBis(N,N′-Di-Tert-Butylacetamindinato) Ruthenium (II).

### Catalyst Deposition and/or Protective Coating Process

In one embodiment, a ruthenium containing is deposited on all the exposed surfaces within fluid channels 161 and 171 in an assembled fuel cell (shown in FIGS. 1 and 2). The exposed surfaces generally include the flow channels and grooves formed in the substrate 23 surface and the surfaces of the anode catalyst region 120 and cathode catalyst region 130. In one aspect, the deposition of ruthenium containing layer is meant to improve the catalytic reactions occurring at the surfaces of the anode catalyst region 120 and/or cathode catalyst region 130. The deposited ruthenium layer can thus be used to 1) fix damaged or discontinuous coatings, 2) further prevent chemical attack of assembled fuel cell components, and 3) also help improve the catalytic efficiency of the one or more catalytic materials disposed on an electrode section of the fuel cell.

To deposit ruthenium on all the exposed surfaces within fluid channels 161 and 171, in one embodiment, the process step 706 is used to deliver ruthenium tetroxide to the exposed components within the fluid channels 161 and 171. In this process an amount of ruthenium tetroxide gas is generated and dispensed into one, or both, of the fluid channels 161 and 171 maintained at a desired temperature until a desired thickness of the ruthenium containing film (e.g., metallic ruthenium or ruthenium dioxide) has been deposited. In one aspect, the mass of the ruthenium tetroxide delivered to the fluid channels 161 and 171 is monitored by measuring the change in weight of the source vessel 641 as a function of time, by use of a conventional electronic scale, load cell, or other weight measurement device. By heating one or more of the fuel cell components to a desired temperature a ruthenium containing layer having desirable properties can be selectively, or non-selectively, deposited of one or more desired surfaces.

It is believed that due to the ability to selectively, or non-selectively, deposit a ruthenium layer at low deposition temperatures (e.g., <200° C.) using a ruthenium tetroxide containing gas, uniquely provides a method that can be used to deposit a ruthenium metal and/or ruthenium dioxide layer on the surfaces contained in the fluid channels to form a catalytic layer and/or make the anode or cathode surfaces of the MEA more conductive. In one aspect, a selective deposition process at temperatures <100° C. is used to form a ruthenium dioxide (RuO₂) layer on desirable surfaces of the MEA structure. The deposition of a ruthenium dioxide layer on the surface of the MEA may be useful to promote the process of catalyzing the reaction at the cathode in which oxygen reacts with protons. In contrast to higher temperature CVD type deposition processes, low temperature deposition schemes can beneficially result in a porous coating on the porous carbon fiber structure commonly used at the electrode surfaces of the MEA. The reaction occurring during the low temperature process causes the some of the carbon at the surface of the MEA to be replaced with a RuO₂ layer. For example, the balanced equation for the reaction is shown in equation (5).

RuO₄+C→RuO₂+CO₂ (5)

A metallic ruthenium layer can be deposited on the carbon at the surface of the MEA at temperatures >250° C. in the presence of a reducing gas. For example, the balanced equation for the reaction is shown in equation (6).

RuO₄+C+2H₂ →Ru+CO₂+2H₂O (6)

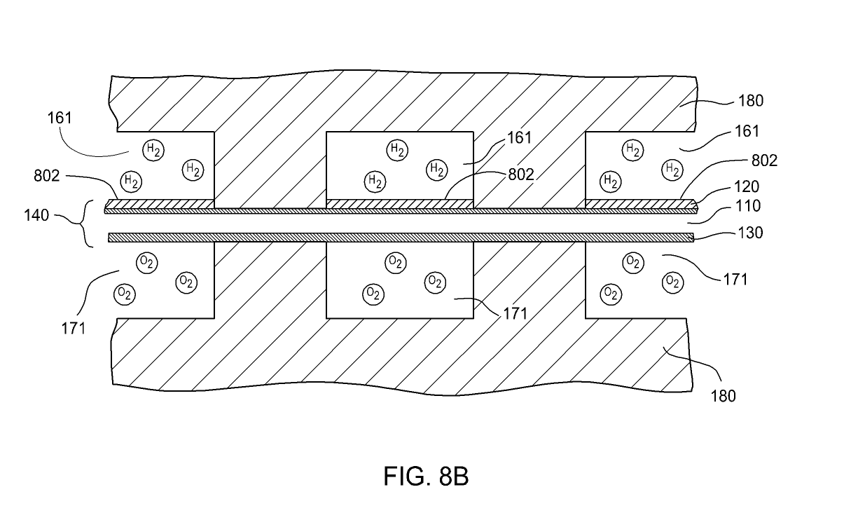

FIGS. 8A and 8B, illustrate a cross-sectional view of the active region 140 of the fuel cell in which a ruthenium layer (e.g., layer 801 or layer 802) is deposited on the surface of the anode catalyst region 120 or cathode catalyst region 130. In FIG. 8A a ruthenium tetraoxide containing gas is delivered through the fluid channel 171 and allowed to interact with the surface of the cathode catalyst region 130 to form a layer 801 on the exposed MEA surface. In one aspect, the layer 801 is a porous ruthenium dioxide layer that has been deposited to promote the catalyzing reaction at the cathode and/or increase the conductivity of the cathode portion of the MEA.

FIG. 8B illustrates a fuel cell that has a ruthenium containing layer (e.g., layer 802) deposited on the surface of the anode portion of the MEA. The layer 802 was deposited by delivering a ruthenium tetraoxide containing gas through the fluid channel 161 so that it is allowed to interact with the surface of the anode catalyst region 120. In one aspect, the layer 802 is a porous metallic ruthenium layer that has been deposited by delivering the ruthenium tetraoxide in the presence of a reducing gas (e.g., hydrogen) to the surface of the MEA that is maintained at a temperature typically greater than about 250° C. The deposition of the metallic ruthenium film will promote the catalyzing reaction at the anode and/or increase the conductivity of the cathode portion of the MEA. In another aspect, the layer 802 is a porous ruthenium dioxide layer that is deposited to promote the catalyzing the reaction at the anode and/or increase the conductivity of the cathode portion of the MEA.

### Ruthenium Treatment of the MEA or MEA Components

In one embodiment, the anode catalyst region 120 and/or cathode catalyst region 130 of a fuel cell is coated with a layer containing ruthenium (Ru) and/or ruthenium dioxide (RuO₂), or a region of Ru and/or RuO₂ adherent particles, that are deposited on the desired regions of a membrane 110 by applying hypophosphorous acid (H₃PO₂) to the surface and exposing the treated surface with ruthenium tetroxide (RuO₄). Hypophosphorous acid is commercially available as an aqueous solution which can selectively applied to various desired surfaces. In one example, a small amount of hypophosphorous acid (e.g., parts-per-million range) may be added to phosphoric acid electrolyte to the membrane 110 or porous electrode surface. In one embodiment, it is desirable to deliver an amount of a solution that contains a desired amount of hypophosphorous acid to control the amount of ruthenium that is deposited. As noted above, the gas permeable region of the anode catalyst region 120 and/or cathode catalyst region 130 of the membrane 110 may be made of carbon paper, cloth-based fibers, graphite materials, or a finely-meshed noble metal screen, foams, polymeric materials, or other materials. In one example, the membrane 110 and gas permeable region are made from a polymeric material, such as a polybenzimidazole (PBI) membrane material. The reaction of hypophosphorous acid with ruthenium tetroxide will generally follow the equation shown in equation (7).

RuO₄+H₃PO₂→RuO₂+H₃PO₄ (7)

The formation of the RuO₂ layer may be performed at room temperature, since hypophosphorous acid is such a strong reducing agent for ruthenium tetroxide. The RuO₂ formed layer can then be further reduced to form metallic ruthenium by exposing the RuO₂ layer to a reducing agent, such as hydrogen gas which is discussed above in conjunction with equation (4). In one aspect, the gas permeable region(s) of the membrane 110 are selectively covered with a dilute hypophosphorous acid containing solution and then exposed to ruthenium tetroxide containing gas to form a region that has a ruthenium containing layer, for example RuO₂, deposited thereon prior to the assembly of the fuel cell 100.

In another embodiment, a membrane 110 in a PAFC cell which contains a phosphoric acid electrolyte is exposed to a ruthenium tetroxide containing gas which allows a ruthenium containing layer, for example RuO₂, to be formed on a surface of the membrane 110. In one example, a RuO₂ layer is deposited on a polybenzimidazole (PBI) membrane that has been impregnated with a phosphoric containing electrolyte at a temperature near room temperature. In another example, a RuO₂ layer is deposited on a polybenzimidazole (PBI) membrane that has been impregnated with a phosphoric containing electrolyte at a temperature near its operating temperature of about 160° C.

In yet another embodiment, a slightly modified PAFC cell that has a membrane 110 that contains a phosphoric acid electrolyte that contains a small amount of hypophosphorous acid (e.g., parts-per-million range), is exposed to a ruthenium tetroxide containing gas which allows a ruthenium containing layer, for example RuO₂, to be formed on a surface of the membrane 110. In one example, the deposition process may be performed at the normal PAFC fuel cell operating temperature of about 160° C. In another example, the ruthenium containing layer disposition process is performed at about room temperature. In one aspect, the membrane 110 can be coated with a ruthenium containing layer when the PAFC cell is fully assembled.

In yet another embodiment, a carbon containing component that is used to later form at least a portion of either the anode catalyst region 120 and/or the cathode catalyst region 130 is coated with a ruthenium containing layer, following the reaction described in equations (5) or (6) above, prior to be assembled within the MEA structure. This configuration thus allows the deposition of a ruthenium containing layer on the catalytic surface(s) prior complete assembly of the MEA structure to prevent the creation of an electrical short between the catalytic regions, and/or blockage or damage to the pore structure within the assembled membranes 110.

While the foregoing is directed to embodiments of the present invention, other and further embodiments of the invention may be devised without departing from the basic scope thereof, and the scope thereof is determined by the claims that follow.

1. A electrode for a fuel cell, comprising:
a substrate having a surface that is adapted to form a portion of a fluid channel in an assembled fuel cell; and
a ruthenium containing layer disposed over the surface.

2. The apparatus of claim 1, wherein the substrate comprises a material selected from a group consisting of silicon, aluminum, titanium, and stainless steel.

3. The apparatus of claim 1, further comprising a first layer disposed underneath the ruthenium containing layer, wherein the first layer comprises a material selected from a group consisting of titanium (Ti), nickel (Ni), titanium nitride (TiN), platinum (Pt), palladium (Pd), tantalum (Ta), tantalum nitride (TaN), iridium (Ir), molybdenum (Mo), osmium (Os), rhenium (Rh), and cobalt (Co).

4. The apparatus of claim 1, further comprising a contact layer disposed over the ruthenium containing layer, wherein the contact layer comprises a material selected from a group consisting of gold, silver, platinum, palladium, iridium, osmium, rhodium, and rhenium.

5. The apparatus of claim 1, further comprising an ion exchange membrane having a catalytic surface forming a portion of a cathode region of the fuel cell, wherein the cathode region is in electrical communication with the ruthenium containing layer.

6. The apparatus of claim 5, further comprising:
a second substrate having a surface that is adapted to form a portion of a fluid channel in the assembled fuel cell; and
a second ruthenium containing layer disposed over the surface of the second substrate, wherein the second ruthenium containing layer is adapted to prevent corrosion of the surface of the second substrate during operation of the fuel cell, and is in electrical communication with a second catalytic surface disposed on a portion of the ion exchange membrane.

7. A fuel cell, comprising:
a membrane electrode assembly comprising a membrane which has a first catalytic surface and a second catalytic surface;
a first conductive plate having one or more surfaces that has a first coating disposed thereon, wherein the first coating is in electrical communication with the first catalytic surface;
a second conductive plate having one or more surfaces that has a second coating disposed thereon, wherein the second coating is in electrical communication with the second catalytic surface, and the second coating comprises a ruthenium containing layer disposed over the one or more surfaces of the second conductive plate.

8. The fuel cell of claim 7, further comprising a first layer disposed over the surface of the second conductive plate and under the ruthenium containing layer.

9. The apparatus of claim 8, wherein the first layer comprises a material selected from a group consisting of titanium (Ti), nickel (Ni), titanium nitride (TiN), platinum (Pt), palladium (Pd), tantalum (Ta), tantalum nitride (TaN), iridium (Ir), molybdenum (Mo), osmium (Os), rhenium (Rh), and cobalt (Co).

10. The fuel cell of claim 7, wherein the one or more conductive plates are selected from the group consisting of separator plates, bipolar plates, end plates, and combinations thereof.

11. The apparatus of claim 7, wherein the first and second conductive plates comprise a material selected from a group consisting of aluminum, titanium, and stainless steel.

12. The apparatus of claim 7, further comprising a contact layer disposed over the ruthenium containing contact layer, wherein the layer comprises a material selected from a group consisting of gold, silver, platinum, palladium, iridium, osmium, rhodium, and rhenium.

13. A method of forming a fuel cell, comprising:
depositing a first layer over at least a portion of one or more channels formed on a surface of a substrate, wherein the one or more channels are adapted to deliver a fuel to an active region of a formed fuel cell; and
depositing a ruthenium containing layer over at least a portion of the first layer.

14. The method of claim 13, wherein the first layer comprises a material selected from a group consisting of titanium, titanium nitride, tantalum, tantalum nitride, nickel, ruthenium, cobalt, platinum, palladium, iridium, molybdenum, osmium, rhodium, and rhenium.

15. The method of claim 13, further comprising depositing a third layer over the second layer, wherein the third layer is selected from a group consisting of rhodium, palladium, osmium, iridium, platinum, silver, tantalum, and gold.

16. The method of claim 13, wherein the second layer comprises a material selected from a group consisting ruthenium and ruthenium dioxide.

17. The method of claim 13, wherein the second layer is formed by exposing the at least a portion of the first layer to a gas comprising ruthenium tetroxide.

18. The method of claim 13, further comprising positioning a membrane electrode so that it is in electrical communication with the ruthenium containing layer.

19. The method of claim 13, wherein the depositing a ruthenium containing layer over at least a portion of the first layer comprises:
disposing a solution comprising hypophosphorous acid over at least a portion of the first layer; and
exposing the at least a portion of the first layer and the solution to a gas comprising ruthenium tetroxide.

20. A method of treating a surface of a substrate that is to be used to form a fuel cell, comprising:
assembling a fuel cell that has at least one fluid channel that is in communication with a catalytic surface of an electrode region of the fuel cell; and
delivering a gas comprising ruthenium tetroxide to the fluid channel and catalytic surface of the electrode region of the fuel cell to deposit a ruthenium containing layer on a portion of the fluid channel or catalytic region.
